(19) United States
(12) Patent Application Publication
(10) Pub. No.: US 2024/0259081 A1
(43) Pub. Date: Aug. 1, 2024

(54) BEAM FAILURE REPORTING WITH EVENT IDENTIFICATION IN A WIRELESS COMMUNICATION SYSTEM

(71) Applicant: QUALCOMM Incorporated, San Diego, CA (US)

(72) Inventors: Hemant Saggar, San Diego, CA (US); Yan Zhou, San Diego, CA (US); Junyi Li, Fairless Hills, PA (US); Tao Luo, San Diego, CA (US)

(21) Appl. No.: 18/161,821

(22) Filed: Jan. 30, 2023

(51) Int. Cl. H04B 7/08; H04W 16/28

(52) U.S. Cl. CPC H04B 7/088; H04W 16/28; H04W 72/20

(57) ABSTRACT

The present disclosure provides systems, apparatuses, methods, and computer-readable media for event identification for beam failure reporting in a wireless communication system. A user equipment (UE) may detect a beam failure event associated with a downlink communication beam and may transmit a beam failure report (BFR) message associated with the beam failure event. The BFR message may include an event identifier (ID) associated with a time of the beam failure event. Alternatively, or in addition to the event ID, the BFR message may include one or more other features, such as an indication of a priority level associated with the BFR message. A network node may receive the BFR message and may transmit a response to the BFR message. The response may indicate one or more operations to be performed by the UE, such as a beam recovery operation to “recover” the downlink communication beam.

### TECHNICAL FIELD

Aspects of the present disclosure relate generally to wireless communication, and more particularly, to beam failure reporting.

### DESCRIPTION OF THE RELATED TECHNOLOGY

Wireless communications systems are widely deployed to provide various types of communication content such as voice, video, packet data, messaging, broadcast, and so on. A wireless multiple-access communications system may include a number of base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

Some wireless communication systems use beamforming to concentrate signal energy in one or more directions. To illustrate, a UE may perform a “sweep” of different beams transmitted by a base station and may select one of the multiple beams based on a signal strength metric (or another metric) associated with the beam. Beamforming may increase efficiency and reliability of communications. In addition, by concentrating signal energy in such a manner, other UEs and devices may experience less noise and interference from communications between the base station and the UE.

In some circumstances, a beam failure event may occur. For example, if the UE changes position relative to the base station or encounters increased noise or interference, the signal strength metric associated with the beam may be reduced, which may cause a beam failure event. The beam failure event may be associated with reduced performance, such as latency or data loss. For example, the UE may experience data or service interruption or latency until completing a beam recovery procedure.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a user equipment (UE). The UE includes at least one memory and at least one processor coupled with the at least one memory. The at least one processor is operable to receive, from a network node, one or more reference signals associated with a plurality of downlink communication beams and to transmit, to the network node, a control message indicating a selection of a downlink communication beam of the plurality of downlink communication beams. The at least one processor is further operable to receive, from the network node, one or more downlink messages via the downlink communication beam and to transmit a beam failure report (BFR) message associated with a beam failure event associated with the downlink communication beam. The BFR message includes an event identifier (ID) associated with a time of the beam failure event.

Another innovative aspect of the subject matter described in this disclosure can be implemented in a method of wireless communication performed by a UE includes receiving, from a network node, one or more reference signals associated with a plurality of downlink communication beams and transmitting, to the network node, a control message indicating a selection of a downlink communication beam of the plurality of downlink communication beams. The method further includes receiving, from the network node, one or more downlink messages via the downlink communication beam and transmitting a BFR message associated with a beam failure event associated with the downlink communication beam. The BFR message includes an event ID associated with a time of the beam failure event.

Another innovative aspect of the subject matter described in this disclosure can be implemented in a network node. The network node includes at least one memory and at least one processor coupled with the at least one memory. The at least one processor is operable to transmit, to a UE, one or more reference signals associated with a plurality of downlink communication beams and to receive, from the UE, a control message indicating a selection of a downlink communication beam of the plurality of downlink communication beams. The at least one processor is further operable to transmit, to the UE, one or more downlink messages via the downlink communication beam and to receive a BFR message associated with a beam failure event associated with the downlink communication beam. The BFR message includes an event ID associated with a time of the beam failure event.

Another innovative aspect of the subject matter described in this disclosure can be implemented in a method of wireless communication performed by a network node. The method includes transmitting, to a UE, one or more reference signals associated with a plurality of downlink communication beams and receiving, from the UE, a control message indicating a selection of a downlink communication beam of the plurality of downlink communication beams. The method further includes transmitting, to the UE, one or more downlink messages via the downlink communication beam and receiving a BFR message associated with a beam failure event associated with the downlink communication beam. The BFR message includes an event ID associated with a time of the beam failure event.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system that supports beam failure reporting with event identification according to one or more aspects.

FIG. 2 is a block diagram illustrating examples of a base station and a user equipment (UE) that support beam failure reporting with event identification according to one or more aspects.

FIG. 3 is a block diagram illustrating an example wireless communication system that supports beam failure reporting with event identification according to one or more aspects.

FIG. 4 is a block diagram illustrating another example wireless communication system that supports beam failure reporting with event identification according to one or more aspects.

FIG. 5 is a timing diagram illustrating example operations that support beam failure reporting with event identification according to one or more aspects.

FIG. 6 is a flow diagram illustrating an example process that supports beam failure reporting with event identification according to one or more aspects.

FIG. 7 is a flow diagram illustrating an example process that supports beam failure reporting with event identification according to one or more aspects.

FIG. 8 is a block diagram of an example UE that supports beam failure reporting with event identification according to one or more aspects.

FIG. 9 is a block diagram of an example base station that supports beam failure reporting with event identification according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The present disclosure provides systems, apparatuses, methods, and computer-readable media for event identification for beam failure reporting in a wireless communication system. A user equipment (UE) may select a downlink communication beam for communication with a network node. In some circumstances, the UE may detect a beam failure event associated with the downlink communication beam. The UE may transmit a beam failure report (BFR) message associated with the beam failure event, and the BFR message may include an event identifier (ID) associated with a time of the beam failure event. To illustrate, the event ID may directly indicate the time of the beam failure event or may indirectly indicate the time of the beam failure event, such as by indicating a “compressed” representation of the time of the beam failure event, which may correspond to a counter value of a counter associated with beam failure events. Alternatively, or in addition to the event ID, the BFR message may include one or more other features, such as an indication of a priority level associated with the BFR message.

Depending on the example, the UE may transmit the BFR message directly to the network node or indirectly to the network node via one or more relay nodes, such as a relay UE (via a sidelink) or a relay network node. One or more such relay devices may relay the BFR message to the network node on behalf of the UE. In some examples, the UE may initiate multiple such transmissions. For example, to increase likelihood that the network node receives the BFR message, the UE may transmit the BFR message directly to the network node and may also indirectly transmit the BFR message to the network node via one or more relay nodes, such as a relay UE or a relay network node. Alternatively, or in addition, the UE may transmit the BFR message to the network node via multiple different communication channels between the UE and the network node, such as via an uplink channel and via a random access channel (RACH).

The network node may receive the BFR message and may transmit a response to the BFR message. Depending on the example, the network node may transmit the response directly to the UE or indirectly to the UE via one or more relay nodes, such as a relay UE or a relay network node. Alternatively, or in addition, the network node may transmit the response to the UE via multiple different communication channels. The response may indicate one or more operations to be performed by the UE, such as a beam recovery operation to “recover” the downlink communication beam.

Particular implementations of the subject matter described in this disclosure can be implemented to realize one or more of the following potential advantages. In some aspects, the present disclosure enables faster and more reliable beam recovery after a beam failure event. For example, if the network node receives multiple transmissions of the BFR message, the network node may identify, using the event ID, that the multiple transmissions are associated with the same beam failure event. In such examples, the network node may use the event ID to “disambiguate” the multiple transmissions of the BFR message. Further, multiple such transmissions of the BFR message may enable the network node to receive and respond to the BFR message more quickly as compared to a single transmission of the BFR message, which may enable the UE to recover from the beam failure event sooner, reducing or avoiding data or service interruption or latency at the UE. Further, by disambiguating such multiple transmissions of the BFR message, the network node may perform a single transmission of the response to the BFR message instead of multiple transmissions of the response, which may reduce signaling and overhead in a wireless communication system.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. In some implementations, two or more wireless communications systems, also referred to as wireless communications networks, may be configured to provide or participate in authorized shared access between the two or more wireless communications systems.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ˜1 M nodes per km\hat{ }2), ultra-low complexity (such as ˜10 s of bits per sec), ultra-low energy (such as ˜10+ years of battery life), and deep coverage with the capability to reach challenging locations; (2) including mission-critical control with strong security to safeguard sensitive personal, financial, or classified information, ultra-high reliability (such as ˜99.99999% reliability), ultra-low latency (such as ˜1 millisecond (ms)), and users with wide ranges of mobility or lack thereof; and (3) with enhanced mobile broadband including extreme high capacity (such as ˜10 Tbps per km\hat{ }2), extreme data rates (such as multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

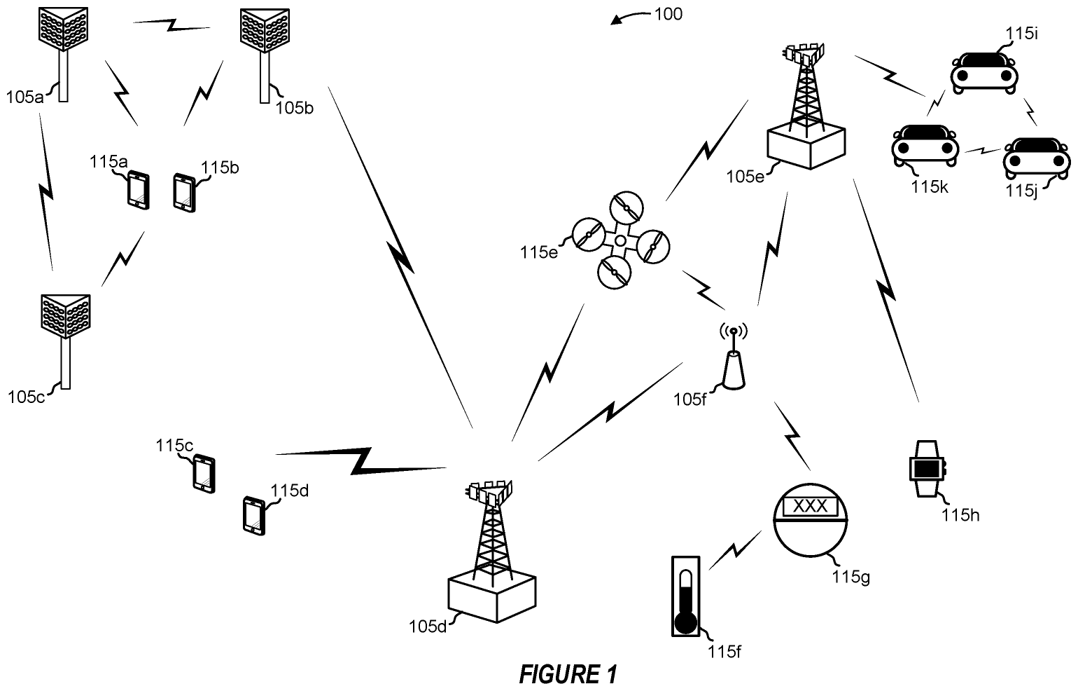

FIG. 1 is a block diagram illustrating details of an example wireless communication system that supports beam failure reporting with event identification according to one or more aspects. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (CoMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

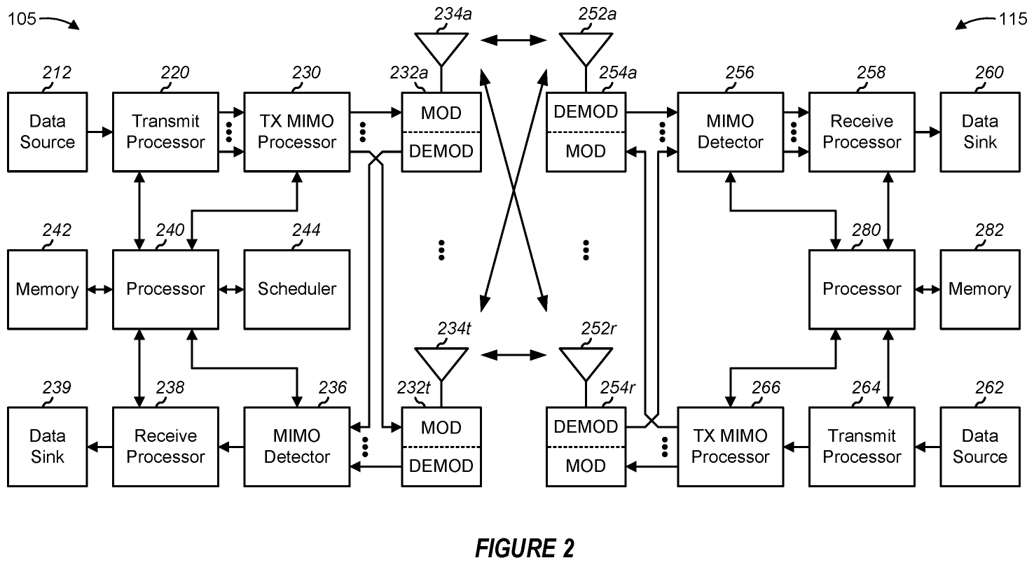

FIG. 2 is a block diagram conceptually illustrating an example design of a base station 105 and a UE 115 that support beam failure reporting with event identification according to one or more aspects. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f. Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a processor 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the processor 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the processor 240.

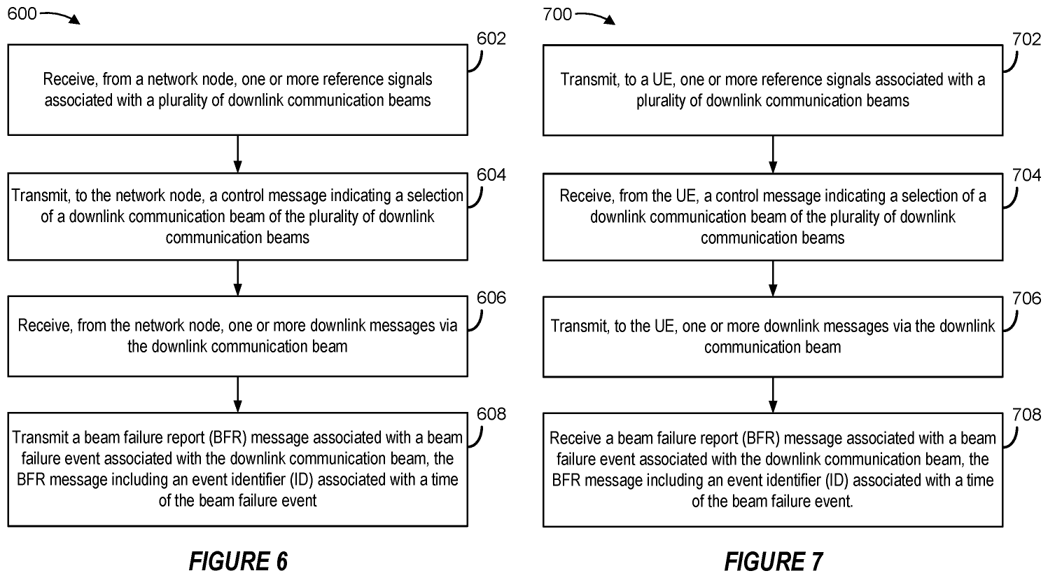

The processors 240 and 280 may direct the operation at the base station 105 and the UE 115, respectively. The processor 240 or other processors and modules at the base station 105 or the processor 280 or other processors and modules at the UE 115 may perform or direct the execution of various processes for the techniques described herein, such as to perform or direct the execution illustrated in FIGS. 6 and 7, or other processes for the techniques described herein. The memories 242 and 282 may store data and program codes for the base station 105 and the UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

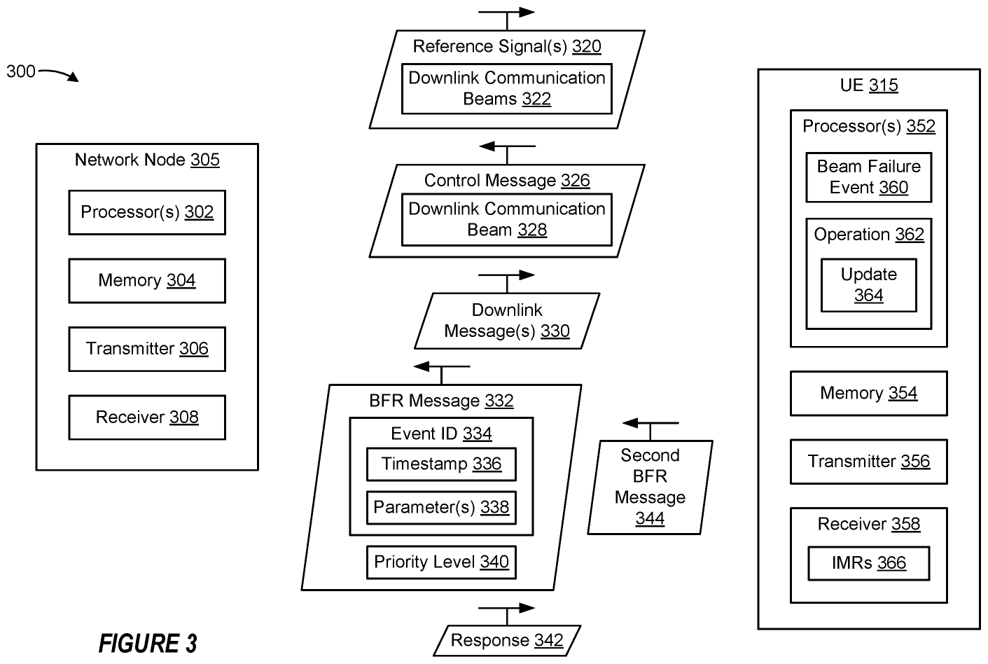

FIG. 3 is a block diagram illustrating an example of a wireless communication system 300 that supports beam failure reporting with event identification according to one or more aspects. The wireless communication system 300 may include a UE 315 (such as the UE 315). The wireless communication system 300 may also include one or more network nodes, such as a network node 305. An example of a network node may be a base station, such as the base station 105. A network node may also be referred to herein as a network entity. Depending on the example, a network node (or network entity) may be implemented as a base station, a network controller, an integrated access and backhauling (IAB) node, a distributed unit (DU), a central unit (CU), or a remote/radio unit (RU) (which may also be referred to as a remote radio unit (RRU)), as illustrative examples.

The network node 305 may include one or more processors 302 (such as the processor 240), a memory 304 (such as the memory 242), a transmitter 306, and a receiver 308. The one or more processors 302 may be coupled to the memory 304, to the transmitter 306, and to the receiver 308. In some examples, the transmitter 306 and the receiver 308 may include one or more components described with reference to FIG. 2, such as one or more of the modulator/demodulators 232a-t, the MIMO detector 236, the receive processor 238, the transmit processor 220, or the TX MIMO processor 230. In some implementations, the transmitter 306 and the receiver 308 may be integrated in one or more transceivers of the network node 305.

The transmitter 306 may be configured to transmit reference signals, synchronization signals, control information, and data to one or more other devices, and the receiver 308 may be configured to receive reference signals, control information, and data from one or more other devices. For example, the transmitter 306 may be configured to transmit signaling, control information, and data to the UE 315, and the receiver 308 may be configured to receive signaling, control information, and data from the UE 315.

The UE 315 may include one or more processors 352 (such as the processor 280), a memory 354 (such as the memory 282), a transmitter 356, and a receiver 358. The one or more processors 352 may be coupled to the memory 354, to the transmitter 356, and to the receiver 358. In some examples, the transmitter 356 and the receiver 358 may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 356 and the receiver 358 may be integrated in one or more transceivers of the UE 315.

The transmitter 356 may transmit reference signals, synchronization signals, control information, and data to one or more other devices, and the receiver 358 may receive reference signals, control information, and data from one or more other devices. For example, in some implementations, the transmitter 356 may transmit signaling, control information, and data to the network node 305, and the receiver 358 may receive signaling, control information, and data from the network node 305.

The wireless communication system 300 may use wireless communication channels, which may be specified by one or more wireless communication protocols, such as a 5G NR wireless communication protocol. To illustrate, the network node 305 may communicate with the UE 315 using one or more downlink wireless communication channels (such as via one or more of a PDSCH or a PDCCH). The UE 315 may communicate with the network node 305 using one or more uplink wireless communication channels (such as via one or more of a PUSCH or a PUCCH). Alternatively, or in addition, the UE 315 may communicate with one or more other UEs, such as via a sidelink wireless communication channel.

During operation, the network node 305 may transmit one or more reference signals 320. For example, the one or more reference signals 320 may include synchronization signal blocks (SSBs). The one or more reference signals 320 may be associated with downlink communication beams 322. For example, the one or more reference signals 320 may include a set of SSBs each transmitted via a respective downlink communication beam of the downlink communication beams 322.

The UE 315 may receive the one or more reference signals 320. In some examples, the UE 315 may perform a beam sweep operation to receive the one or more reference signals 320. Performing the beam sweep operation may further include selecting a downlink communication beam 328 from among the downlink communication beams 322. For example, the UE 315 may identify the downlink communication beam 322 based on a comparison of a signal strength (or other metric) associated with the downlink communication beam 322 to a signal strength (or other metric) associated with other downlink communication beams of the downlink communication beams 322.

The UE 315 may transmit a control message 326 indicating a selection of the downlink communication beam 328. In some examples, the control message 326 may include a physical random access channel (PRACH) preamble indicating the downlink communication beam 328.

The network node 305 may receive the control message 326. The network node 305 may perform downlink communications in accordance with the downlink communication beam 328 indicated by the control message 326. For example, the network node 305 may transmit one or more downlink messages 330 to the UE 315 using the downlink communication beam 328.

The UE 315 may receive the one or more downlink messages 330 via the downlink communication beam 328. In some circumstances, the UE 315 may detect a beam failure event 360 associated with at least one of the one or more downlink messages 330. For example, one or more other beams may interfere with the downlink communication beam 328. The one or more other beams may include a beam used by the UE 315, which may result in self-interference (SI) that may cause the beam failure event 360. Alternatively, or in addition, the one or more other beams may include a beam used by another UE, which may result in cross-link interference (CLI) that may cause the beam failure event 360. The one or more other beams may include one or more of an uplink communication beam, a downlink communication beam, or a sidelink communication beam, as illustrative examples. The one or more other beams may be referred to as interfering beams.

In some examples, the UE 315 may detect the beam failure event 360 (or may detect information indicating the beam failure event 360) using interference measurement resources (IMRs) 366 (such as by performing one or more measurements using the IMIRs 366), which may be configured by the network node 305 (or by another network node). The EIRs 366 may include one or more of time resources, frequency resources, or beam resources specifying where the UE 315 is to perform an interference measurement. To further illustrate, the UE 315 may use the EIRs 366 to perform one or more of a reference signal received power (RSRP) measurement, an SI measurement, a CLI measurement, or one or more other measurements that may indicate information associated with the beam failure event 360. Such information may indicate a reason for the beam failure event 360 or a type of operation to perform or indicate to the network node 305 to recover from the beam failure event 360, as illustrative examples.

Alternatively, or in addition, the network node 305 may configure the UE 315 with one or more beam failure detection reference signals (BFD-RSs), and the UE 315 may use the one or more BFD-RSs to monitor for and detect the beam failure event 360. In some examples, the BFD-RSs may be periodic, semi-persistent or aperiodic and may enable the UE 315 to detect and recover from the beam failure event 360 prior to a downlink data transmission that may affected by the beam failure event 360. In some examples, the UE 315 may use the IMRs 366 to receive the one or more BFD-RSs.

The UE 315 may transmit a beam failure report (BFR) message 332 associated with the beam failure event 360. In some examples, the UE 315 may transmit the BFR message 332 via a medium access control (MAC) control element (MAC-CE) or via another type of signaling. The UE 315 may transmit the BFR message 332 to the network node 305 via one or more communication paths. To illustrate, the one or more communication paths may include one or more direct communication paths between the UE 315 and the network node 305, one or more indirect communication paths between the UE 315 and the network node 305, or a combination thereof.

In an example of a direct communication path, the UE 315 may transmit the BFR message 332 directly to the network node 305, such as without using an intervening device (such as a relay device). For example, the UE 315 may transmit the BFR message 332 to the network node 305 using an uplink communication channel with the network node 305, such as via a PUCCH transmission to the network node 305. Alternatively, or in addition, the UE 315 may transmit the BFR message 332 to the network node 305 using one or more other communication channels, such as using random access channel (RACH) via a RACH procedure.

In an example of an indirect communication path, the UE 315 may transmit the BFR message 332 to one or more other devices (such as one or more other UEs, one or more other network nodes, or a combination thereof), and the one or more other devices may forward the BFR message 332 to the network node 305. In some examples, the UE 315 may transmit the BFR message 332 to another UE via a sidelink, and the other UE may forward the BFR message 332 to the network node 305 on behalf of the UE 315. The UE 315 may use such an indirect communication path alternatively, or in addition, to using a direct communication path. Accordingly, the UE 315 may transmit the BFR message 332 via one or more direct communication paths from the UE 315 to the network node 305, via one or more relay devices that are to relay the BFR message to the network node 305 (where the one or more relay devices may include one or more of a relay network node or a relay UE), or a combination thereof.

The BFR message 332 may include an event identifier (ID) 334 associated with a time of the beam failure event 360. In some implementations, the event ID 334 may include or correspond to a timestamp 336 associated with the time of the beam failure event 360. For example, the timestamp 336 may directly indicate the time of the beam failure event 360. In some other examples, the timestamp 336 may be a “compressed” representation of the time of the beam failure event. For example, the timestamp 336 may be selected from a set of values, and each different beam failure event (such as the beam failure event 360) may be associated with a different value of the set of values. As a result, different values of the event ID 334 may indicate different beam failure events occurring at different times. In some implementations, use of the set of values may reduce a quantity of bits included in the event ID 334 as compared to directly indicating actual time of the beam failure event 360 (which may involve a relatively large quantity of bits in some implementations).

To further illustrate, in some implementations, the timestamp 336 may indicate a time difference between a reference timepoint and the time of the beam failure event 360, such as a quantity of symbols between the reference timepoint and the time of the beam failure event 360. The reference timepoint may be “known” to the UE 315 and the network node 305, such as if the reference timepoint is specified by a wireless communication protocol associated with the UE 315 and the network node 305. Further, the reference timepoint may be periodically or occasionally updated (or “reset”). To illustrate, if reference timepoint corresponds to symbol 50, and if the beam failure event 360 occurs at symbol 65, then the timestamp 336 may indicate 15 symbols (to indicate the difference between symbol 65 and symbol 50). If the reference timepoint is updated every 200 symbols, and if a subsequent beam failure event occurs at symbol 275, then the subsequent beam failure event may be associated with a timestamp of 25 symbols (to indicate the difference between symbol 275 and symbol 250).

In some examples, the UE 315 may include a counter for beam failure events. For each beam failure event detected by the UE 315, the UE 315 may determine a counter value of the counter (such as by incrementing the counter to determine the counter value) that is associated with each such beam failure event. In such examples, the event ID 334 may include a counter value that is associated with the time of the beam failure event 360. Further, in some implementations, the timestamp 336 may include or may indicate the counter value. Other examples are also within the scope of the disclosure.

In some implementations, the BFR message 332 may further indicate one or more parameters 338 associated with the beam failure event 360. To illustrate, the one or more parameters 338 may include one or more of a beam identifier associated with the downlink communication beam 328, a failure type associated with the beam failure event 360, an identifier associated with network node 305, or an indication of an interfering beam associated with the beam failure event 360.

In some examples, the BFR message 332 may include, for each of the one or more parameters 338, a field associated with the parameter that has a size that is in accordance with a quantity of bits of the parameter. To illustrate, in some examples, the one or more parameters 338 may include a parameter indicating a failure type of the beam failure event 360 and having a bit that indicates whether the failure type is an SI failure type or a CLI failure type. In some such examples, the BFR message 332 may include a field having a size of one bit.

The event ID 334 may include a quantity of bits (such as K, where K>0) selected from a domain of bits, such as [0, 2\hat{ }(K−1)]. In some implementations, the value of K may be selected in accordance with a quantity of parameters of the one or more parameters 338. In some such examples, a size in bits of the event ID 334 may be associated with, or may be selected in accordance with a quantity of parameters of the one or more parameters 338, such as by increasing (or decreasing) K for a greater (or lesser) quantity of parameters of the one or more parameters 338. Depending on the implementation, the UE 315 may select event IDs (such as the event ID 334) from the domain of bits in increasing order, in decreasing order, in random or pseudo-random order, or using another technique. In some examples, the network node 305 may configure the UE 315 with the value of K, such as via RRC signaling. As explained further below, in some implementations, the event ID 334 may be available for “re-use” (or reselection from the domain of bits) after one or more criteria are satisfied, such as after the UE 315 receives a reply to the BFR message 332 or after performing an operation in accordance with the reply, such as one or more of a beam recovery operation, a beam switch, a transmission configuration indictor (TCI) update, an SI measurement, a CLI measurement, or another operation.

In some other examples, the event ID 334 may be a combination of at least the timestamp 336 and the one or more parameters 338. In some such examples, instead of including a separate field for each of the timestamp 336 and the one or more parameters 338, the BFR message 332 may include a field for the event ID 334, and the event ID 334 may represent a combination of the timestamp 336 and the one or more parameters 338.

In some implementations, the UE 315 may selectively include the event ID 334 in the BFR message 332. To illustrate, the UE 315 may include the event ID 334 in the BFR message 332 if the UE 315 detects that one or more criteria are satisfied, or the UE 315 may exclude the event ID 334 from the BFR message 332 if the UE 315 detects that the one or more criteria are not satisfied. To illustrate, the UE 315 may include the event ID 334 in the BFR message 332 associated with one or more of there being multiple communication paths from the UE 315 to the network node 305, information included in the BFR message 332 other than the event ID 334 being insufficient to enable the network node 305 to identify the beam failure event, or there being a conflict between the BFR message 332 and one or more other BFR messages to be transmitted to the network node 305. In such examples, including the event ID 334 in the BFR message 332 may enable the network node 305 to identify whether the BFR message 332 is associated with a common beam failure event as one or more other BFR messages received by the network node 305 and may reduce the probability of a false or missed detection of a beam failure event (such as the beam failure event 360) at the UE 315.

In some other examples, the UE 315 may exclude the event ID 334 from the BFR message 332, such as if the UE 315 initiates a single transmission of the BFR message 332. As another example, the UE 315 may exclude the event ID 334 from the BFR message 332 if each transmission of multiple transmissions of the BFR message 332 is to have at least one parameter (such as a parameter of the one or more parameters 338) that is to differ from the others of the multiple transmissions, in which case the network node 305 may distinguish among the multiple transmissions in accordance with the at least one parameter.

Alternatively, or in addition to the event ID 334, the BFR message 332 may include an indication of a priority level 340 associated with the beam failure event 360. To illustrate, in some circumstances, the UE 315 may retransmit the BFR message 332 if the UE 315 fails to receive a response to the initial transmission of the BFR message 332 within a threshold time interval. In some wireless communication protocols, each such retransmission may be associated with a greater probability of a radio link failure (RLF) event, which may interrupt service or connectivity of the UE 315. As a result, the initial transmission may indicate a first priority level, and a retransmission may indicate a second priority level greater than the first priority level. As another example, the UE 315 may increase the priority level 340 if the UE 315 is to receive downlink data that is relatively delay sensitive, such as in connection with an ultra-reliable low-latency communication (URLLC) application, a virtual reality (VR) application, an augmented reality (AR) application, or an extended reality (XR) application. As an additional example, if the UE 315 is able to reduce or avoid SI by changing from a full-duplex (FD) mode to a half-duplex (HD) mode, the UE 315 may decrease the priority level 340. As a further example, the UE 315 may increase the priority level 340 if the UE 315 is unable to avoid interference associated with the beam failure event 360, such as if the beam failure event 360 is associated with CLI from one or more other UEs.

To further illustrate, the UE 315 may determine the priority level 340 in accordance with one or more criteria. In some examples, the priority level 340 may be associated with one or more of a time interval between detecting the beam failure event 360 and transmission of the BFR message 332, a failure type of the beam failure event 360, a UE capability of the UE 315 to recover from the beam failure event 360, a service interruption associated with the beam failure event 360, or a data interruption associated with the beam failure event 360.

In some examples, the UE 315 may transmit the BFR message 332 at a transmission time that is associated with the priority level 340, such as by selecting the transmission time in accordance with the priority level 340. For example, if the priority level 340 indicates that the BFR message 332 is relatively urgent, then the UE 315 may cancel or delay one or more scheduled uplink or sidelink transmissions (or one or more portions thereof) in order to transmit the BFR message 332.

To further illustrate, if the priority level 340 exceeds a threshold, the UE 315 may determine that the BFR message 332 is more urgent than one or more other messages or data to be transmitted by the UE 315. In some such examples, the BFR message 332 may “preempt” the one or more other messages or data. In some such examples, the UE 315 may avoid multiplexing the BFR message 332 with the one or more other messages or data. In some other examples, if the priority level 340 fails to exceed the threshold, the UE 315 may multiplex the BFR message 332 with the one or more other messages or data. Similarly, in examples in which a forwarding device forwards the BFR message 332 from the UE 315 to the network node 305 (such as a UE that receives the BFR message 332 from the UE 315 via a sidelink), the forwarding device may also select a transmission time for the BFR message 332 in accordance with the priority level 340.

In some implementations, the BFR message 332 indicates both the event ID 334 and the priority level 340, and the event ID 334 and the priority level 340 are selected from a common space, such as a common set of values. To illustrate, the BFR message 332 may include a first value associated with the event ID 334 and a second value associated with the priority level 340, and both the first value and the second value may be selected from the common space.

The event ID 334 may be selected from a respective common space across links or cells. To illustrate, one or more features of the BFR message 332 may be different if UE 315 transmits the BFR message 332 via a sidelink as compared to via a direct communication link between the UE 315 and the network node 305. Accordingly, the event ID 334 may be included in an event ID space associated with multiple communication paths from the UE 315 to the network node 305. In such examples, the event ID space may be common to the multiple communication paths. In some other examples, the event ID 334 may be included in a first event ID space associated with a first communication path of multiple communication paths from the UE 315 to the network node 305, and a second communication path of the multiple communication paths may be associated with a second event ID space that is distinct from the first event ID space. In such examples, each communication path may be associated with a different respective event ID space.

Similarly, the priority level 340 may be selected from a respective common space across links or cells. To illustrate, in some examples, the priority level 340 may be included in a priority space associated with multiple communication paths from the UE 315 to the network node 305. In such examples, the priority space may be common to the multiple communication paths. In some other examples, the priority level 340 may be included in a first priority space associated with a first communication path of multiple communication paths from the UE 315 to the network node 305, and a second communication path of the multiple communication paths may be associated with a second priority space that is distinct from the first priority space. In such examples, each communication path may be associated with a different respective priority space.

The network node 305 may receive the BFR message 332. In some examples, the network node 305 may receive multiple transmissions of the BFR message 332 via multiple communication paths. The multiple communication paths may include one or more communication channels between the UE 315 and the network node 305 (such as one or more of a PUCCH transmission or a RACH transmission), one or more relay devices (such as via one or more of another network node or another UE), or a combination thereof. In some examples, the network node 305 may determine, using the event ID 334, that the multiple transmissions of the BFR message 332 are associated with the beam failure event 360.

The network node 305 may transmit a response 342 associated with the BFR message 332. Depending on the example, the network node 305 may transmit the response 342 directly to the UE 315 or indirectly to the UE 315 via one or more relay nodes, such as a relay UE or a relay network node. The response 342 may indicate at least one operation 362 to be performed by the UE 315 associated with the beam failure event 360. For example, the at least one operation 362 may include one or more of a beam recovery operation, a beam switch, a TCI update, an SI measurement, a CLI measurement, or another operation. The UE 315 may receive the response 342 (such as from the network node 305 or from a relay device) and may perform the at least one operation 362 in accordance with the response 342. Alternatively, or in addition, the network node 305 may perform one or more other operations associated with the BFR message 332. For example, the network node 305 may configure or reconfigure one or more resources (such as sounding reference signal (SRS) resources or other resources) of one or more other UEs causing CLI at the UE 315 that results in the beam failure event 360, which may avoid one or more subsequent such beam failure events.

To illustrate, the UE 315 may detect the beam failure event 360 (or may detect information associated with the beam failure event 360) using the IMRs 366 (such as by performing one or more measurements using the IMRs 366), and performing the at least one operation 362 may include performing an update 364, in accordance with the response 342, on at least one of the EIRs 366. For example, the EIRs 366 may include a first time resource, a first frequency resource, and one or more first measurement beams, and the update 364 may include one or more of changing from the first time resource to a second time resource, changing from the first frequency resource to a second frequency resource, or changing from the one or more first measurement beams to one or more second measurement beams. In some examples, a measurement beam may include a receive beam or a transmit beam.

To further illustrate, the update 364 may be associated with a change of the one or more first measurement beams to the one or more second measurement beams, and UE 315 may adjust a quasi-colocation (QCL) parameter associated with the EIRs 366 to perform the change to the one or more second measurement beams. Alternatively, or in addition, the update 364 may be associated with a change of one or more of the first time resource to the second time resource or the first frequency resource to the second frequency resource, and the response 342 (or another message) may indicate one or more of the second time resource or the second frequency resource.

In some circumstances, the UE 315 may transmit multiple different BFR messages associated with multiple different beam failure events prior to receiving a response to any of the multiple BFR messages. To illustrate, after transmitting the BFR message 332, the UE 315 may detect another beam failure event (other than the beam failure event 360) and may transmit at least one other BFR message after transmitting the BFR message 332 and prior to receiving the response 342. In some such examples, the response 342 may be associated with multiple BFR messages including the BFR message 332 and the at least one other BFR message. In some examples, the BFR message 332 and the at least one other BFR message may include different event IDs associated with different beam failure events, and the network node 305 may “bundle” responses to the different beam failure events via the response 342. Further, the different event IDs may enable the network node 305 to distinguish between the different beam failure events.

In some other examples, instead of including a different event ID in a BFR message, the UE 315 may “reuse” one or more features of the BFR message 332 in another BFR message, such as in one or more other BFR messages. For example, the UE 315 may reuse the event ID 334 in the one or more other BFR messages if the UE 315 determines that inclusion of the event ID 334 in the one or more other BFR messages will not create ambiguity with respect to the BFR message 332.

To illustrate, the UE 315 may identify, in accordance with receiving the response 342, that the event ID 334 is available for reuse in the one or more other BFR messages. In such examples, one or both of the network node 305 or the UE 315 may determine, based on transmission of the response 342, that the event ID 334 is no longer associated with the beam failure event 360 and is available for the one or more other BFR messages.

In some other examples, the UE 315 may identify, in accordance with performing the at least one operation 362, that the event ID 334 is available for reuse in the one or more other BFR messages. In such examples, one or both of the network node 305 or the UE 315 may determine, based on performance of the at least one operation 362, that the event ID 334 is no longer associated with the beam failure event 360 and is available for the one or more other BFR messages.

In some circumstances, the network node 305 may receive multiple BFR messages. In such examples, the network node 305 may use information included in the multiple BFR messages to determine an order in which to respond to the multiple BFR messages, to determine whether to “bundle” responses to the multiple BFR messages, to determine whether to discard one or more of the multiple BFR messages, or to determine whether to perform one or more other operations. To illustrate, the network node 305 may receive the BFR message 332 and may further receive a second BFR message 344 (such as from the UE 315 or from another device forwarding the second BFR message 344 for the UE 315) a time interval after receipt of the BFR message 332. In some examples, the second BFR message 344 may include a second event ID to indicate that the second BFR message 344 is associated with a second beam failure event that is different than the beam failure event 360.

In some other examples, both the BFR message 332 and the second BFR message 344 may include the event ID 334 and may be associated with a same priority level (such as the priority level 340). In some such examples, the network node 305 may “bundle” responses to the BFR message 332 and the second BFR message 344, such as via the response 342. In some other examples, if the network node identifies that the time interval between receiving the BFR message 332 and the second BFR message 344 exceeds a threshold time interval, the network node 305 may discard the second BFR message 344. In some other examples, instead of discarding the second BFR message 344, the network node 305 may perform a soft combining of one or more first bits of the BFR message 332 with one or more second bits of the second BFR message 344. In some other examples, the network node 305 may perform a logical OR operation using the BFR message 332 and the second BFR message 344.

In some other examples, both the BFR message 332 and the second BFR message 344 may include the event ID 334 and may be associated with different priority levels (such as the priority level 340 and another priority level, respectively). In some such examples, the network node 305 may select one of the BFR message or the second BFR message 344 in accordance with the different priority levels (such as by selecting the BFR message having the greater priority) and may transmit a response to the selected one of the BFR message 332 or the second BFR message 344. The response may correspond to the response 342 or another response. The response may be associated with each BFR message associated with the event ID 334. In such examples, the UE 315 may automatically determine, in accordance with the response, that each such BFR message associated with the event ID 334 is resolved (and that no further replies to the BFR messages associated with the event ID 334 are outstanding).

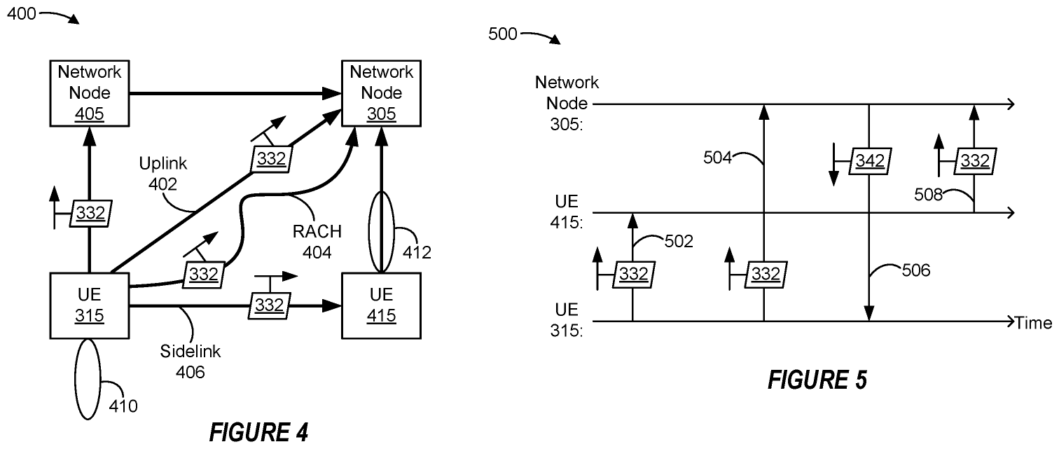

FIG. 4 is a block diagram illustrating another example wireless communication system 400 that supports beam failure reporting with event identification according to one or more aspects. In the example of FIG. 4, the wireless communication system 400 may include the network node 305, the UE 315, and one or more relay nodes, such as a network node 405 and a UE 415.

During operation, the UE 315 may experience a beam failure event, such as the beam failure event 360. For example, a beam 410 used by the UE 315 to communicate with the network node 305 may be misdirected with respect to the location of the UE 315 with respect to the network node 305.

To enable recovery from the beam failure event 360, the UE 315 may initiate multiple transmissions of the BFR message 332. For example, the UE 315 may transmit the BFR message 332 to the network node 305 via an uplink 402 and via a RACH 404. Alternatively, or in addition, the multiple transmissions may include one or more of a transmission to the network node 405 or a transmission to the UE 415 (such as via a sidelink 406). In some examples, the network node 405 and the UE 415 may relay the BFR message 332 to the network node 305. For example, the UE 415 may use a beam 412 to relay the BFR message 332 to the network node 305.

Although not illustrated in FIG. 4, the network node 305 may transmit the response 342 in accordance with receiving one or more transmissions of the BFR message 332. For example, the network node 305 may transmit the response 342 directly to the UE 315 (such as using a downlink communication channel), indirectly to the UE 315 using one or more relay devices (such as one or more of the network node 405 or the UE 415), or a combination thereof.

By including the event ID 334 in the BFR message 332, the network node 305 may identify that each transmission of the BFR message 332 is associated with the same beam failure event, such as the beam failure event 360. In some examples, in accordance with the event ID 334, the network node 305 may perform a single transmission of the response 342 instead of performing multiple transmissions of the response 342, which may reduce signaling and overhead in the wireless communication system 400.

FIG. 5 is a timing diagram illustrating example operations 500 that support beam failure reporting with event identification according to one or more aspects. The operations 500 may include transmitting, by the UE 315, the BFR message 332 to the UE 415, at 502. For example, the UE 315 may transmit the BFR message 332 to the UE 415 via the sidelink 406 of FIG. 4. The operations 500 may further include transmitting, by the UE 315, the BFR message 332 to the network node 305, at 504.

The network node 305 may receive the BFR message 332. The operations 500 may further include transmitting, by the network node 305, the response 342 to the ULE 315, at 506. At 508, the operations 500 may further include relaying, by the UE 415, the BFR message 332 to the network node 305. For example, in some circumstances, relaying operations may be of a relatively low priority for the UE 415. As a result, the UE 415 may relay the BFR message 332 to the network node 305 relatively late after receiving the BFR message 332 from the UE 315.

By including the event ID 334 in the BFR message 332, the network node 305 may identify that each transmission of the BFR message 332 is associated with the same beam failure event, such as the beam failure event 360. In some examples, in accordance with the event ID 334, the network node 305 may perform a single transmission of the response 342 instead of performing multiple transmissions of the response 342, which may reduce signaling and overhead in a wireless communication system.

One or more aspects described herein may enable faster and more reliable beam recovery after a beam failure event, such as the beam failure event 360. For example, if the network node 305 receives multiple transmissions of the BFR message 332, the network node 305 may identify, using the event ID 334, that the multiple transmissions are associated with the same beam failure event 360. In such examples, the network node 305 may use the event ID 334 to “disambiguate” the multiple transmissions of the BFR message 332. Further, multiple such transmissions of the BFR message 332 may enable the network node 305 to receive and respond to the BFR message 332 more quickly as compared to a single transmission of the BFR message 332, which may enable the UE 315 to recover from the beam failure event 360 sooner, reducing or avoiding data or service interruption or latency at the UE 315. Further, by disambiguating such multiple transmissions of the BFR message 332, the network node 305 may perform a single transmission of the response 342 instead of multiple transmissions of the response 342, which may reduce signaling and overhead in a wireless communication system.

FIG. 6 is a flow diagram illustrating an example process 600 that supports beam failure reporting with event identification according to one or more aspects. Operations of the process 600 may be performed by a UE, such as the UE 115 described above with reference to FIGS. 1-2 or the UE 315 of FIG. 3. Example operations (also referred to as “blocks”) of the process 600 may enable the UE to support beam failure reporting with event identification.

In block 602, the UE receives, from a network node, one or more reference signals associated with a plurality of downlink communication beams. For example, the UE 315 may receive, from the network node 305, the one or more reference signals 320 associated with the plurality of downlink communication beams 322.

In block 604, the UE transmits, to the network node, a control message indicating a selection of a downlink communication beam of the plurality of downlink communication beams. For example, the UE 315 may transmit, to the network node 305, the control message 326 indicating selection of the downlink communication beam 328 of the plurality of downlink communication beams 322.

In block 606, the UE receives, from the network node, one or more downlink messages via the downlink communication beam. For example, the UE 315 may receive, from the network node 305, the one or more downlink messages 330 via the downlink communication beam 328.

In block 608, the UE transmits a BFR message associated with a beam failure event associated with the downlink communication beam. The BFR message includes an event ID associated with a time of the beam failure event. For example, the UE 315 may transmit the BFR message 332 associated with the beam failure event 360. The BFR message 332 may include the event ID 334 associated with a time of the beam failure event 360.

FIG. 7 is a flow diagram illustrating an example process 700 that supports beam failure reporting with event identification according to one or more aspects. Operations of the process 700 may be performed by a network node, such as the base station 105 described above with reference to FIGS. 1-2 or the network node 305 of FIG. 3. Example operations (also referred to as “blocks”) of the process 700 may enable the network node to support beam failure reporting with event identification.

In block 702, the network node transmits, to a UE, one or more reference signals associated with a plurality of downlink communication beams. For example, the network node 305 may transmit, to the UE 315, the one or more reference signals 320 associated with the plurality of downlink communication beams 322.

In block 704, the network node receives, from the UE, a control message indicating a selection of a downlink communication beam of the plurality of downlink communication beams. For example, the network node 305 may transmit, to the UE 315, the control message 326 indicating selection of the downlink communication beam 328 of the plurality of downlink communication beams 322.

In block 706, the network node transmits, to the UE, one or more downlink messages via the downlink communication beam. For example, the network node 305 may transmit, to the UE 315, the one or more downlink messages 330 via the downlink communication beam 328.

In block 708, the network node receives a BFR message associated with a beam failure event associated with the downlink communication beam. The BFR message includes an event ID associated with a time of the beam failure event. For example, the network node 305 may receive the BFR message 332 associated with the beam failure event 360. The BFR message 332 may include the event ID 334 associated with a time of the beam failure event 360.

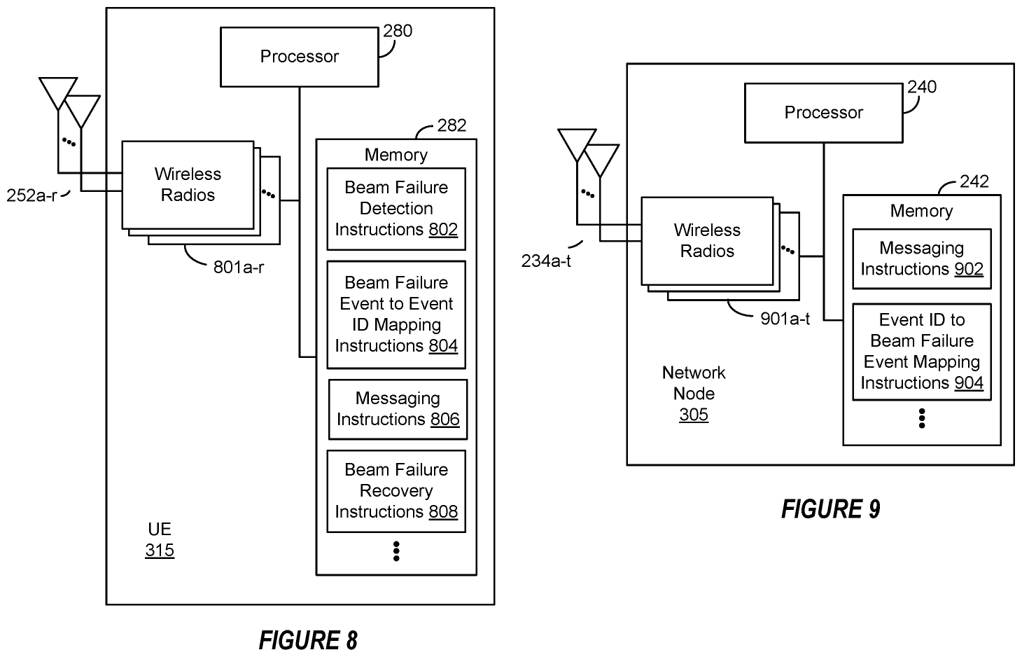

FIG. 8 is a block diagram of an example UE 315 that supports beam failure reporting with event identification according to one or more aspects. The UE 315 may be configured to perform operations, including the blocks of the process 600 described with reference to FIG. 6. The UE 315 may include the processor 280, which operates to execute logic or computer instructions stored in the memory 282, as well as controlling the components of the UE 315 that provide the features and functionality of the UE 315. The UE 315, under control of the processor 280, transmits and receives signals via wireless radios 801a-r and the antennas 252a-r. The wireless radios 801a-r include various components and hardware, as illustrated in FIG. 2 for the UE 115, including the modulator and demodulators 254a-r, the MIMO detector 256, the receive processor 258, the transmit processor 264, and the TX MIMO processor 266. Alternatively, or in addition, the wireless radios 801a-r may include one or more of the transmitter 356 or the receiver 358 of FIG. 3.

The memory 282 may store instructions executable by the processor 280 to initiate, control, or perform one or more operations described herein. For example, the memory 282 may store beam failure detection instructions 802 executable by the processor 280 to detect beam failure events, such as the beam failure event 360. As another example, the memory 282 may store beam failure event to event ID mapping instructions 804 executable by the processor 280 to determine the event ID 334 in accordance with the beam failure event 360. As a further example, the memory 282 may store messaging instructions 806 executable by the processor 280 to transmit the BFR message 332. As an additional example, the memory 282 may store beam failure recovery instructions 808 executable by the processor 280 to perform beam recovery associated with the beam failure event 360, such as by performing the at least one operation 362.

FIG. 9 is a block diagram of an example network node 305 that supports beam failure reporting with event identification according to one or more aspects. The network node 305 may be configured to perform operations, including the blocks of the process 700 described with reference to FIG. 7. The network node 305 may include the processor 240, which operates to execute logic or computer instructions stored in the memory 242, as well as controlling the components of the network node 305 that provide the features and functionality of the network node 305. The network node 305, under control of the processor 240, transmits and receives signals via wireless radios 901a-t and the antennas 234a-t. The wireless radios 901a-t include various components and hardware, as illustrated in FIG. 2 for the base station 105, including the modulator and demodulators 232a-t, the transmit processor 220, the TX MIMO processor 230, the MIMO detector 236, and the receive processor 238. Alternatively, or in addition, the wireless radios 901a-t may include one or more of the transmitter 306 or the receiver 308 of FIG. 3.

The memory 242 may store instructions executable by the processor 240 to initiate, control, or perform one or more operations described herein. For example, the memory 242 may store messaging instructions 902 executable by the processor 240 to receive the BFR message 332. As an additional example, the memory 242 may store event ID to beam failure event mapping instructions 904 to identify, in accordance with the event ID 334, that one or more transmissions of the BFR message 332 are associated a common beam failure event, such as the beam failure event 360.

According to some further aspects, in a first aspect, a UE includes at least one memory and at least one processor coupled with the at least one memory. The at least one processor is operable to receive, from a network node, one or more reference signals associated with a plurality of downlink communication beams and to transmit, to the network node, a control message indicating a selection of a downlink communication beam of the plurality of downlink communication beams. The at least one processor is further operable to receive, from the network node, one or more downlink messages via the downlink communication beam and to transmit a BFR message associated with a beam failure event associated with the downlink communication beam. The BFR message includes an event ID associated with a time of the beam failure event.

In a second aspect, in combination with the first aspect, the BFR message further indicates one or more parameters associated with the beam failure event, the one or more parameters including one or more of a beam identifier associated with the downlink communication beam, a failure type associated with the beam failure event, an identifier associated with the network node, or an indication of an interfering beam associated with the beam failure event.

In a third aspect, in combination with any of the first aspect or the second aspect, the at least one processor is further operable to receive a response to the BFR message from the network node or from a relay device, and the response indicates at least one operation to be performed by the UE associated with the beam failure event.

In a fourth aspect, in combination with any of the first aspect through the third aspect, the at least one processor is further operable to identify, associated with receiving the response, that the event ID is available for reuse in one or more other BFR messages.

In a fifth aspect, in combination with any of the first aspect through the fourth aspect, the at least one processor is further operable to perform the at least one operation and identify, associated with the performance of the at least one operation, that the event ID is available for reuse in one or more other BFR messages.

In a sixth aspect, in combination with any of the first aspect through the fifth aspect, the BFR message further includes an indication of a priority level associated with the beam failure event.

In a seventh aspect, in combination with any of the first aspect through the sixth aspect, the at least one processor is further operable to perform the transmission of the BFR message via one or more of: one or more direct communication paths from the UE to the network node; or one or more relay devices that are to relay the BFR message to the network node, the one or more relay devices including one or more of a relay network node or a relay UE.

In an eighth aspect, in combination with any of the first through the seventh aspect, the event ID includes a counter value that is associated with the time of the beam failure event.

In a ninth aspect, a method of wireless communication performed by a UE includes receiving, from a network node, one or more reference signals associated with a plurality of downlink communication beams and transmitting, to the network node, a control message indicating a selection of a downlink communication beam of the plurality of downlink communication beams. The method further includes receiving, from the network node, one or more downlink messages via the downlink communication beam and transmitting a BFR message associated with a beam failure event associated with the downlink communication beam. The BFR message includes an event ID associated with a time of the beam failure event.

In a tenth aspect, in combination with the ninth aspect, the BFR message further indicates one or more parameters associated with the beam failure event, the one or more parameters including one or more of a beam identifier associated with the downlink communication beam, a failure type associated with the beam failure event, an identifier associated with the network node, or an indication of an interfering beam associated with the beam failure event.

In an eleventh aspect, in combination with any of the ninth through the tenth aspect, the method further includes receiving a response to the BFR message from the network node or from a relay device, and the response indicates at least one operation to be performed by the UE associated with the beam failure event.

In a twelfth aspect, in combination with any of the ninth through the eleventh aspect, identifying, associated with receiving the response, that the event ID is available for reuse in one or more other BFR messages.

In a thirteenth aspect, in combination with any of the ninth through the twelfth aspect, the method further includes performing the at least one operation and identifying, associated with the performance of the at least one operation, that the event ID is available for reuse in one or more other BFR messages.

In a fourteenth aspect, in combination with any of the ninth through the thirteenth aspect, the BFR message further includes an indication of a priority level associated with the beam failure event.

In a fifteenth aspect, in combination with any of the ninth through the fourteenth aspect, the BFR message is transmitted via one or more of: one or more direct communication paths from the UE to the network node; or one or more relay devices that are to relay the BFR message to the network node, the one or more relay devices including one or more of a relay network node or a relay UE.

In a sixteenth aspect, in combination with any of the ninth through the fifteenth aspect, the event ID includes a counter value that is associated with the time of the beam failure event.

In a seventeenth aspect, network node includes at least one memory and at least one processor coupled with the at least one memory. The at least one processor is operable to transmit, to a UE, one or more reference signals associated with a plurality of downlink communication beams and to receive, from the UE, a control message indicating a selection of a downlink communication beam of the plurality of downlink communication beams. The at least one processor is further operable to transmit, to the UE, one or more downlink messages via the downlink communication beam and to receive a BFR message associated with a beam failure event associated with the downlink communication beam. The BFR message includes an event ID associated with a time of the beam failure event.

In an eighteenth aspect, in combination with the seventeenth aspect, the BFR message further indicates one or more parameters associated with the beam failure event, the one or more parameters including one or more of a beam identifier associated with the downlink communication beam, a failure type associated with the beam failure event, an identifier associated with the network node, or an indication of an interfering beam associated with the beam failure event.

In a nineteenth aspect, in combination with any of the seventeenth aspect or the eighteenth aspect, the at least one processor is further operable to transmit a response to the BFR message to the UE or to a relay device, and the response indicates at least one operation to be performed by the UE associated with the beam failure event.

In a twentieth aspect, in combination with any of the seventeenth aspect through the nineteenth aspect, the at least one processor is further operable to identify, associated with transmitting the response or with performance of the at least one operation by the UE, that the event ID is available for reuse in one or more other BFR messages.

In a twenty-first aspect, in combination with any of the seventeenth aspect through the twentieth aspect, the BFR message further includes an indication of a priority level associated with the beam failure event.

In a twenty-second aspect, in combination with any of the seventeenth aspect through the twenty-first aspect, the at least one processor is further operable to receive the BFR message via one or more of: one or more direct communication paths from the UE to the network node; or one or more relay devices that are to relay the BFR message to the network node, the one or more relay devices including one or more of a relay network node or a relay UE.

In a twenty-third aspect, in combination with any of the seventeenth aspect through the twenty-second aspect, the event ID includes a counter value that is associated with the time of the beam failure event.

In a twenty-fourth aspect, a method of wireless communication performed by a network node includes transmitting, to a UE, one or more reference signals associated with a plurality of downlink communication beams and receiving, from the UE, a control message indicating a selection of a downlink communication beam of the plurality of downlink communication beams. The method further includes transmitting, to the UE, one or more downlink messages via the downlink communication beam and receiving a BFR message associated with a beam failure event associated with the downlink communication beam. The BFR message includes an event ID associated with a time of the beam failure event.

In a twenty-fifth aspect, in combination with any of the twenty-fourth aspect through the twenty-fourth aspect, the BFR message further indicates one or more parameters associated with the beam failure event, the one or more parameters including one or more of a beam identifier associated with the downlink communication beam, a failure type associated with the beam failure event, an identifier associated with the network node, or an indication of an interfering beam associated with the beam failure event.

In a twenty-sixth aspect, in combination with any of the twenty-fourth aspect through the twenty-fifth aspect, the method further includes transmitting a response to the BFR message to the UE or to a relay device, and the response indicates at least one operation to be performed by the UE associated with the beam failure event.

In a twenty-seventh aspect, in combination with any of the twenty-fourth aspect through the twenty-sixth aspect, the method further includes identifying, associated with transmitting the response or with performance of the at least one operation by the UE, that the event ID is available for reuse in one or more other BFR messages.

In a twenty-eighth aspect, in combination with any of the twenty-fourth aspect through the twenty-seventh aspect, the BFR message further includes an indication of a priority level associated with the beam failure event.

In a twenty-ninth aspect, in combination with any of the twenty-fourth aspect through the twenty-eighth aspect, the BFR message is received via one or more of: one or more direct communication paths from the UE to the network node; or one or more relay devices that are to relay the BFR message to the network node, the one or more relay devices including one or more of a relay network node or a relay UE.

In a thirtieth aspect, alone or in combination with any of the twenty-fourth aspect through the twenty-ninth aspect, the event ID includes a counter value that is associated with the time of the beam failure event.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A user equipment (UE) comprising:
at least one memory; and
at least one processor coupled with the at least one memory, the at least one processor operable to:
receive, from a network node, one or more reference signals associated with a plurality of downlink communication beams;
transmit, to the network node, a control message indicating a selection of a downlink communication beam of the plurality of downlink communication beams;
receive, from the network node, one or more downlink messages via the downlink communication beam; and
transmit a beam failure report (BFR) message associated with a beam failure event associated with the downlink communication beam, the BFR message including an event identifier (ID) associated with a time of the beam failure event.

2. The UE of claim 1, wherein the BFR message further indicates one or more parameters associated with the beam failure event, the one or more parameters including one or more of a beam identifier associated with the downlink communication beam, a failure type associated with the beam failure event, an identifier associated with the network node, or an indication of an interfering beam associated with the beam failure event.

3. The UE of claim 1, wherein the at least one processor is further operable to receive a response to the BFR message from the network node or from a relay device, and wherein the response indicates at least one operation to be performed by the UE associated with the beam failure event.

4. The UE of claim 3, wherein the at least one processor is further operable to identify, associated with receiving the response, that the event ID is available for reuse in one or more other BFR messages.

5. The UE of claim 3, wherein the at least one processor is further operable to:
perform the at least one operation; and
identify, associated with the performance of the at least one operation, that the event ID is available for reuse in one or more other BFR messages.

6. The UE of claim 1, wherein the BFR message further includes an indication of a priority level associated with the beam failure event.

7. The UE of claim 1, wherein the at least one processor is further operable to perform the transmission of the BFR message via one or more of:
one or more direct communication paths from the ULE to the network node; or
one or more relay devices that are to relay the BFR message to the network node, the one or more relay devices including one or more of a relay network node or a relay UE.

8. The UE of claim 1, wherein the event ID includes a counter value that is associated with the time of the beam failure event.

9. A method of wireless communication performed by a user equipment (UE), the method comprising:
receiving, from a network node, one or more reference signals associated with a plurality of downlink communication beams;
transmitting, to the network node, a control message indicating a selection of a downlink communication beam of the plurality of downlink communication beams;
receiving, from the network node, one or more downlink messages via the downlink communication beam; and
transmitting a beam failure report (BFR) message associated with a beam failure event associated with the downlink communication beam, the BFR message including an event identifier (ID) associated with a time of the beam failure event.

10. The method of claim 9, wherein the BFR message further indicates one or more parameters associated with the beam failure event, the one or more parameters including one or more of a beam identifier associated with the downlink communication beam, a failure type associated with the beam failure event, an identifier associated with the network node, or an indication of an interfering beam associated with the beam failure event.

11. The method of claim 9, further comprising receiving a response to the BFR message from the network node or from a relay device, wherein the response indicates at least one operation to be performed by the UE associated with the beam failure event.

12. The method of claim 11, further comprising identifying, associated with receiving the response, that the event ID is available for reuse in one or more other BFR messages.

13. The method of claim 11, further comprising:
performing the at least one operation; and
identifying, associated with the performance of the at least one operation, that the event ID is available for reuse in one or more other BFR messages.

14. The method of claim 9, wherein the BFR message further includes an indication of a priority level associated with the beam failure event.

15. The method of claim 9, wherein the BFR message is transmitted via one or more of:
one or more direct communication paths from the ULE to the network node; or
one or more relay devices that are to relay the BFR message to the network node, the one or more relay devices including one or more of a relay network node or a relay UE.

16. The method of claim 9, wherein the event ID includes a counter value that is associated with the time of the beam failure event.

17. A network node comprising:
at least one memory; and
at least one processor coupled with the at least one memory, the at least one processor operable to:
transmit, to a user equipment (UE), one or more reference signals associated with a plurality of downlink communication beams;
receive, from the UE, a control message indicating a selection of a downlink communication beam of the plurality of downlink communication beams;
transmit, to the UE, one or more downlink messages via the downlink communication beam; and
receive a beam failure report (BFR) message associated with a beam failure event associated with the downlink communication beam, the BFR message including an event identifier (ID) associated with a time of the beam failure event.

18. The network node of claim 17, wherein the BFR message further indicates one or more parameters associated with the beam failure event, the one or more parameters including one or more of a beam identifier associated with the downlink communication beam, a failure type associated with the beam failure event, an identifier associated with the network node, or an indication of an interfering beam associated with the beam failure event.

19. The network node of claim 17, wherein the at least one processor is further operable to transmit a response to the BFR message to the UE or to a relay device, and wherein the response indicates at least one operation to be performed by the UE associated with the beam failure event.

20. The network node of claim 19, wherein the at least one processor is further operable to identify, associated with transmitting the response or with performance of the at least one operation by the UE, that the event ID is available for reuse in one or more other BFR messages.

21. The network node of claim 17, wherein the BFR message further includes an indication of a priority level associated with the beam failure event.

22. The network node of claim 17, wherein the at least one processor is further operable to receive the BFR message via one or more of:
one or more direct communication paths from the UE to the network node; or
one or more relay devices that are to relay the BFR message to the network node, the one or more relay devices including one or more of a relay network node or a relay UE.

23. The network node of claim 17, wherein the event ID includes a counter value that is associated with the time of the beam failure event.

24. A method of wireless communication performed by a network node, the method comprising:
transmitting, to a user equipment (UE), one or more reference signals associated with a plurality of downlink communication beams;
receiving, from the UE, a control message indicating a selection of a downlink communication beam of the plurality of downlink communication beams;
transmitting, to the UE, one or more downlink messages via the downlink communication beam; and
receiving a beam failure report (BFR) message associated with a beam failure event associated with the downlink communication beam, the BFR message including an event identifier (ID) associated with a time of the beam failure event.

25. The method of claim 24, wherein the BFR message further indicates one or more parameters associated with the beam failure event, the one or more parameters including one or more of a beam identifier associated with the downlink communication beam, a failure type associated with the beam failure event, an identifier associated with the network node, or an indication of an interfering beam associated with the beam failure event.

26. The method of claim 24, further comprising transmitting a response to the BFR message to the UE or to a relay device, and wherein the response indicates at least one operation to be performed by the UE associated with the beam failure event.

27. The method of claim 26, further comprising identifying, associated with transmitting the response or with performance of the at least one operation by the UE, that the event ID is available for reuse in one or more other BFR messages.

28. The method of claim 24, wherein the BFR message further includes an indication of a priority level associated with the beam failure event.

29. The method of claim 24, wherein the BFR message is received via one or more of:
one or more direct communication paths from the ULE to the network node; or
one or more relay devices that are to relay the BFR message to the network node, the one or more relay devices including one or more of a relay network node or a relay UE.

30. The method of claim 24, wherein the event ID includes a counter value that is associated with the time of the beam failure event.
